(19) United States
(12) Patent Application Publication
(10) Pub. No.: US 2013/0228028 A1
(43) Pub. Date: Sep. 5, 2013

(54) WORM WHEEL FOR ELECTRIC POWER STEERING APPARATUS AND METHOD FOR MANUFACTURING THE SAME

(71) Applicant: MANDO CORPORATION, Pyeongtaek-si (KR)

(72) Inventors: Seong Soo KIM, Seoul (KR); Hee Chul AHN, Yongin-si (KR)

(73) Assignee: MANDO CORPORATION, Pyeongtaek-si (KR)

(21) Appl. No.: 13/782,856

(22) Filed: Mar. 1, 2013

(30) Foreign Application Priority Data
Mar. 2, 2012 (KR) 10-2012-0021570

(51) Int. Cl. F16H 55/17

(52) U.S. Cl. CPC F16H 55/17
USPC 74/434; 264/279

(57) ABSTRACT

Disclosed is a worm wheel of a reducer of an electric power steering apparatus which is manufactured by integrally injection-molding a hub, a boss, and a gear forming part, thereby making it possible to increase a forming performance of the worm wheel and reduce an amount of material, and increasing a mechanical durability and frictional characteristics of the worm wheel to allow the reducer to be stably used for a long time, and a method for manufacturing the same.

### CROSS-REFERENCE TO RELATED APPLICATION

This application claims priority from and the benefit uncle-35 U.S.C. §119(a) of Korean Patent Application No. 10-2012-0021570, filed on Mar. 2, 2012, which is hereby incorporated by reference for all purposes as if fully set forth herein.

### BACKGROUND OF THE INVENTION

1. Field of the Invention

The present invention relates to a worm wheel for an electric power steering apparatus and a method for manufacturing the same, and more particularly to a worm wheel of a reducer of an electric power steering apparatus which is manufactured by integrally injection-molding a hub, a boss, and a gear forming part, thereby making it possible to increase a forming performance of the worm wheel and reduce an amount of material, and increasing a mechanical durability and frictional characteristics of the worm wheel to allow the reducer to to be stably used for a long time, and a method for manufacturing the same.

2. Description of the Prior Art

In general, a power steering apparatus mounted to a vehicle includes an electric power steering apparatus a steering force of which is adjusted by a motor. In the electric power steering apparatus, an electronic control unit precisely drives the motor according to a travel condition of the vehicle detected by various sensors such as a speed sensor and a steering torque sensor, and a torque generated by the motor is transmitted to a steering column or a pinion via a reducer to assist a steering force of the driver who manipulates a steering wheel connected to the steering column and the pinion.

Accordingly, the electric power steering apparatus provides a light and comfortable steering state during a low speed travel of the vehicle, provides a heavy and stable steering state during a high speed travel of the vehicle, and allows the driver to cope with an unexpected emergency situation to perform a steering operation rapidly in the emergency situation, thereby providing the driver with a steering performance for maintaining an optimum steering condition.

Such an electric power steering apparatus is classified into various types according to a mounting location thereof, and is an apparatus in which a reducer including a motor is installed mainly at a portion of a steering column for fixing a steering shaft connecting a steering wheel of a driver's seat and a gear box at a lower portion of the vehicle, or a portion of a gear box in which a pinion coupled to a rack bar is installed, so that a rotating force of the steering wheel manipulating by the driver can be transmitted to the rack bar by the motor and the reducer.

FIG. 1 is a sectional view illustrating an internal structure of a reducer of an electric power steering apparatus installed in a generally used column.

The reducer is configured such that a worm shaft 104 formed of a metal material such as steel and having a worm 102 at a middle portion thereof is installed in the reducer, worm bearings 106 are installed at opposite ends of the worm shaft 104, respectively, to support the worm shaft 104, and the worm shaft 104 and a motor shaft 108 are connected to each other so that the worm shaft 104 is rotated by driving a motor 110.

A worm wheel 114 formed, for example, of a resin composition is provided at one side of an outer surface of the worm 102 formed at a middle portion of the worm shaft 104 to be engaged with the worm 102. The worm wheel 114 is mounted to a steering shaft 112 for transmitting a rotating force of a steering wheel (not illustrated) manipulated by the driver such that a rotating force of the worm shaft 104 due to a driving operation of the motor 110 is transferred to the steering shaft 112. The worm wheel 114 and the worm shaft 104 engaged with each other in a worm gear fashion is mounted to an interior of a housing 116 to be protected from the outside.

As the electronic control unit (not illustrated) provided in the vehicle controls a driving operation of the motor 110 according to a travel condition of the vehicle and a rotating force of the worm shaft 104 due to the driving operation of the motor 110 is transmitted to the steering shaft 112 in addition to a rotating force of the steering wheel manipulated by the driver, a steering operating state by the driver can be maintained softly and stably.

Here, the worm wheel of the reducer functions to reduce a rotating speed of the motor and transmit the reduced speed to the steering shaft, and as described above, a gear formed of a resin composition and a gear formed of a metal composition may form a pair.

However, when the worm wheel of the reducer is formed of a resin composition, forming performance deteriorates and material costs increase. Further, since the worm shaft, the worm wheel, and the steering shaft rotated together are engaged with each other, a torsion load and vibrations generated by the rotations may be severely transmitted, deteriorating durability of parts or damaging parts in violent cases.

In particular, when the vehicle travels on an uneven road, a load transmitted from a wheel via a rack bar and a steering shaft may increase instantaneously, deforming or damaging their shapes, which may cause a safety accident to the driver.

### SUMMARY OF THE INVENTION

Accordingly, the present invention has been made to solve the above-mentioned problems occurring in the prior art, and an object of the present invention is to provide a worm wheel of a reducer of an electric power steering apparatus which is manufactured by integrally injection-molding a hub, a boss, and a gear forming part, thereby making it possible to increase a forming performance of the worm wheel and reduce an amount of material, and increasing a mechanical durability and frictional characteristics of the worm wheel to allow the reducer to to be stably used for a long time, and a method for manufacturing the same.

In order to accomplish this object, there is provided a worm wheel of an electric power steering apparatus which has a central portion coupled to a steering shaft and an outer periphery coupled to a worm shaft to provide an assistant steering force, the worm wheel including: a hollow hub into which the steering shaft is inserted; a gear forming part having a worm wheel gear engaged with a worm gear of the worm shaft at an outer periphery thereof; and a boss integrally formed between an outer periphery of the hub and an inner periphery of the gear forming part.

An uneven part may be formed on an outer peripheral surface of the hub.

The gear forming part may have a small diameter portion protruding inward and formed circumferentially on an inner peripheral surface, and a plurality of bosses protruding axially may be formed on upper and lower surfaces of the small diameter portion, respectively.

The boss may include an inner tube surrounding an outer peripheral surface of the hub, an outer tube surrounding an inner peripheral surface of the gear forming part, and a separation plate separating opposite circumferential surfaces of the inner tube and the outer tube such that the opposite circumferential surfaces of the inner tube and the outer tube are symmetrical upward and downward and radially connecting the opposite circumferential surfaces of the inner tube and the outer tube.

The boss may have a plurality of ribs radially extending from an outer peripheral surface of the inner tube to be circumferentially spaced apart from each other by a distance, the ribs being integrally connected to an inner peripheral surface of the outer tube and the separation plate.

In accordance with another object of the present invention, there is provided a method for manufacturing a worm wheel of an electric power steering apparatus, the method including: injection-molding a molten resin in a mold to form a gear forming part having a worm wheel gear at an outer periphery thereof and having a small diameter portion circumferentially formed at an inner periphery thereof and protruding inward and a plurality of bosses protruding axially from an upper surface and a lower surface of the small diameter portion, respectively; and inserting a hub into a center of the gear forming part to fix the hub to the mold and injection-molding a molten resin between an outer periphery of the hub and an inner periphery of the gear forming part to form a boss.

The method may further include: demolding the formed resin formed in the forming of the gear forming part from the mold, removing the formed resin covering an inner side of the small diameter portion, and exposing an inner peripheral surface of the small diameter portion to perform a turning operation on the gear forming part.

The method may further include: demolding the formed resin formed in the forming of the boss from the mold, removing the formed resin covering an upper side of the hub, and exposing an inner peripheral surface of the hub to perform a turning operation on the boss.

As described above, according to the present invention, a worm wheel of a reducer of an electric power steering apparatus can be manufactured by integrally injection-molding a hub, a boss, and a gear forming part, thereby making it possible to increase a forming performance of the worm wheel and reduce an amount of material, and increasing a mechanical durability and frictional characteristics of the worm wheel to allow the reducer to be stably used for a long time.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating an internal structure of a reducer of an electric power steering apparatus installed in a generally used column;

FIG. 2 is a perspective view illustrating a worm wheel of an electric power steering apparatus according to the present invention;

FIGS. 3 and 4 are perspective views illustrating a gear forming part of the worm wheel of the electric power steering apparatus according to the present invention;

FIG. 5 is a perspective view illustrating a hub and the gear forming part of the worm wheel of the electric power steering apparatus according to the present invention; and

FIG. 6 illustrates a sectional view and a perspective view illustrating a state in which the worm wheel of the electric power steering apparatus according to the present invention is formed.

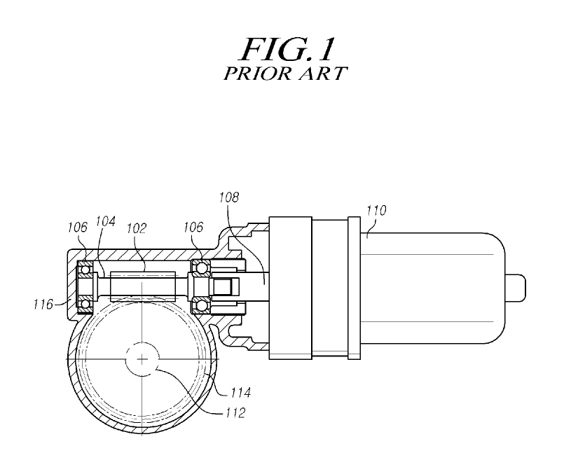

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected”, “coupled” or “joined” to another component, a third component may be “connected”, “coupled”, and “joined” between the first and second components, although the first component may be directly connected, coupled or joined to the second component.

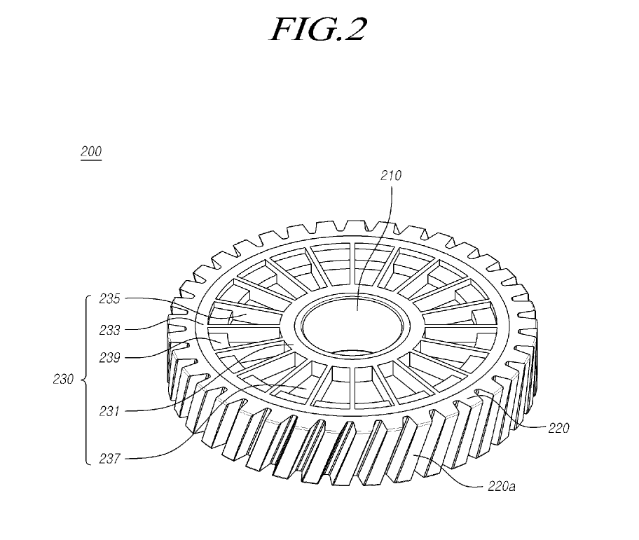

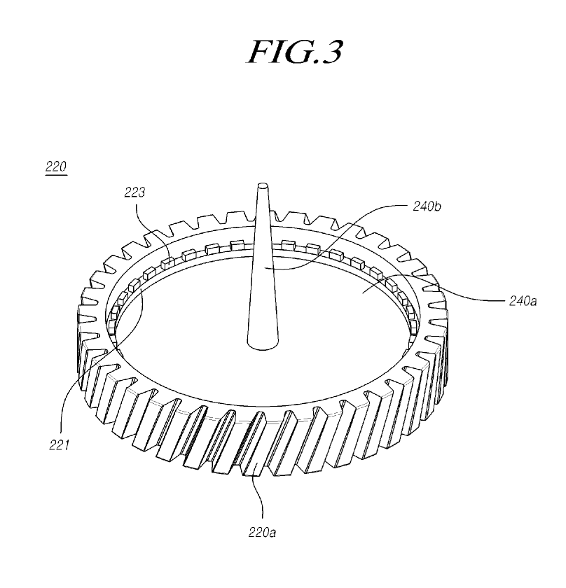

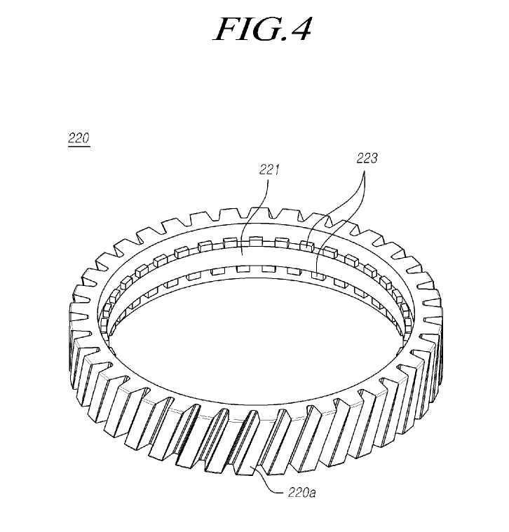

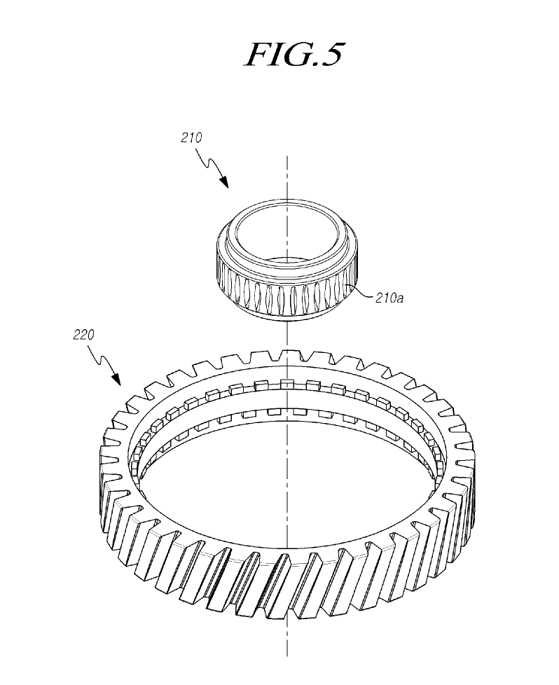

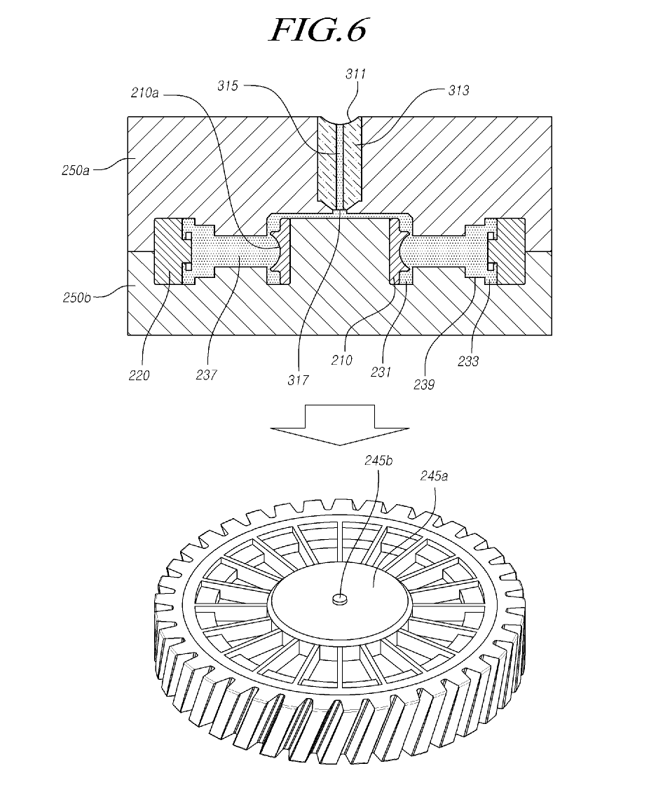

FIG. 2 is a perspective view illustrating a worm wheel of an electric power steering apparatus according to the present invention. FIGS. 3 and 4 are perspective views illustrating a gear forming part of the worm wheel of the electric power steering apparatus according to the present invention. FIG. 5 is a perspective view illustrating a hub and the gear forming part of the worm wheel of the electric power steering apparatus according to the present invention. FIG. 6 illustrates a sectional view and a perspective view illustrating a state in which the worm wheel of the electric power steering apparatus according to the present invention is formed.

A worm shaft formed of a metal material such as steel and having a worm gear at a middle portion thereof is provided in a reducer, and a worm wheel is provided at one side of an outer periphery of the worm shaft to be engaged with the worm gear formed at a middle portion of the worm shaft.

The reducer rotates a steering shaft while the worm shaft and the worm wheel are moved in conjunction with each other to assist a steering force of the driver, worm shaft bearings are coupled to opposite ends of the worm shaft moved in association with a shaft of a motor during a driving operation of the motor to support rotation of the warm shaft, and the worm wheel and the worm shaft moved in conjunction with the steering shaft is installed within a gear housing.

Meanwhile, a steering shaft for transmitting a rotating force of the steering wheel to a rack bar when the driver manipulates the steering wheel is connected from the steering wheel to a gear box within which a column, a universal joint, a rack gear, and a pinion gear, and the reducer may be coupled to the column and the steering shaft (or pinion) installed within the gear box.

Thus, if the worm shaft is rotated by a driving operation of the motor, the worm wheel is rotated in conjunction with the worm shaft, in which case the worm wheel is coupled to the steering shaft of the column or the steering shaft of the gear box to assist a steering force of the driver.

Here, a central portion of the worm wheel 200 is coupled to the steering shaft and an outer periphery thereof is coupled to the worm shaft to provide an assistant steering force. The worm wheel 200 includes a hollow hub 210 into which the steering shaft is inserted, a gear forming part 220 having a worm wheel gear 220a engaged with a worm gear of the worm shaft at an outer periphery thereof, and a boss 230 integrally formed between an outer periphery of the hub 210 and an inner periphery of the gear forming part 220.

The steering shaft is coupled to penetrate into a central portion of the substantially ring-shaped steel hub 210, and an uneven part 210a is integrally formed on an outer peripheral surface of the hub 210 to prevent a slip with the boss 230.

The gear forming part 220 has a small diameter portion 221 circumferentially formed on an inner peripheral surfce of the gear forming part 220 and protruding inward, and a plurality of protrusions 223 protruding axially are formed on upper and lower surfaces of the small diameter portion 221.

Thus, the boss 230 integrally injection-molded at an inner periphery of the gear forming part 220 is prevented from slipping from the gear forming part 220 so that a coupling force therebetween is increased.

The boss 230 mainly includes an inner tube 231, an outer tube 233, and a separation plate 237 connecting the inner tube 231 and the outer tube 233.

The inner tube 231 has a pipe shape surrounding an outer peripheral surface of the hub 210, the outer tube 233 has a pipe shape surrounding an inner peripheral surface of the gear forming part 220, and the separation plate 237 connects the outer peripheral surface of the inner tube 231 and the inner peripheral surface of the outer tube 233.

The separation plate 237 has a horizontal disk shape having a predetermined thickness which radially connects the inner tube 231 and the outer tube 233 while separating opposite circumferential surfaces of the inner tube 231 and the outer tube 233 such that the opposite circumferential surfaces of the inner tube 231 and the outer tube 233 are symmetrical to each other upward and downward.

The outer tube 233 fills an empty space between a small diameter portion 221 and bosses 223 formed on an inner peripheral surface of the gear forming part 220 to be injection-molded.

The boss 230 has a plurality of ribs 235 radially extending from an outer peripheral surface of the inner tube 231 to be circumferentially spaced apart from each other by a distance, the ribs 235 being integrally connected to an inner peripheral surface of the outer tube 233 and the separation plate 237.

That is, a plurality of ribs 235 are radially formed on upper and lower sides of the separation plate 237 symmetrically separating the opposite circumferential surfaces of the inner tube 231 and the outer surface 233 upward and downward, respectively, and are integrally connected to the inner tube 231, the outer tube 233, and the separation plate 237.

A reinforcing part 239 integrally connecting the ribs 235 and the outer tube 233 are provided additionally, and as illustrated in FIG. 2, the reinforcing part 239 connects an inner peripheral surface of the outer tube 233 and side surfaces of the ribs 235 to be stepped at an end of the outer tube 233.

In this way, since the boss 230 has the ribs 235 circumferentially spaced apart from each other by a predetermined distance, the boss 230 more firmly supports a torsion load generated when the steering shaft coupled to the hub 210 is rotated, preventing the hub 210 from being deformed and damaged while reducing material costs and reducing weight.

The ribs 235 can support a torsion load generated between the inner tube 231 of the boss 230 receiving a rotating force from the steering shaft and the outer tube 233 of the boss 230 receiving a rotating force from the worm shaft.

Meanwhile, a method for manufacturing a worm wheel of an electric power steering apparatus includes the steps of: injection-molding a molten resin in a mold to form a gear forming part 220 having a worm wheel gear 220a at an outer periphery thereof and having a small diameter portion 221 circumferentially formed at an inner periphery thereof and protruding inward and a plurality of bosses 223 protruding axially from an upper surface and a lower surface of the small diameter portion 221, respectively; and inserting a hub 210 into a center of the gear forming part 220 to fix the hub 210 to the mold and injection-molding a molten resin between an outer periphery of the hub 210 and an inner periphery of the gear forming part 220 to form a boss 230.

First, as illustrated in FIGS. 3 and 4, the gear forming part 220 is formed by injection-molding a molten resin in the mold having the worm wheel gear 220a, the small diameter portion 221, and the bosses 223.

The gear forming part 220 has a worm wheel gear 220a at an outer periphery thereof and has a small diameter portion 221 circumferentially formed at an inner periphery thereof and protruding inward and a plurality of bosses 223 protruding axially from an upper surface and a lower surface of the small diameter portion 221, respectively, and as illustrated in FIG. 3, a formed resin substance 240a covering an inner side of the small diameter portion 221 and a gate residual substance 240b are left in the molten resin finished in the mold.

Thus, a step of demolding the formed resin formed in the forming of the gear forming part 220 from the mold, removing the formed resin substance 240a covering an inner side of the small diameter portion 221 and the gate residual substance 240b and exposing an inner peripheral surface of the small diameter portion 221 to perform a turning operation on the gear forming part 220 is performed.

After the step of performing a turning operation on the gear forming part 220, as illustrated in FIG. 4, the worm wheel gear 220a is formed at an outer periphery of the gear forming part 220 and the small diameter portion 221 and the bosses 223 are formed at an inner periphery of the gear forming part 220.

If the gear forming part 220 is finished, as illustrated in FIG. 5, a hub 210 is inserted into a center of the gear forming part 220 so that the hub 210 is fixed to the mold and a molten resin is injection-molded between an outer periphery of the hub 210 and an inner periphery of the gear forming part 220 so that the boss 230 is fixed.

The step of forming the boss 230 is performed by a hot runner injection-molding apparatus as illustrated in an upper picture of FIG. 6, and an upper mold 250a and a lower mold 250b surrounding the worm wheel such that the upper mold 250a and the lower mold 250b are symmetrical to each other upward and downward are prepared and a sprue 311 in which a nozzle (not illustrated) of a molten resin extruder is located, a resin passage 315, and a hot runner part 313 having a gate 317 are provided in the upper mold 250a.

A plurality of sprues 311 may be formed such that the molten resin supplied from the molten resin extruder is branched and supplied by a hot runner manifold (not illustrated), and a plurality of hot runner parts 313 may be formed.

The resin passage 315 and the gate 317 are formed at a lower end of the sprue 311, and the molten resin supplied from the gate 317 during an opening operation of the nozzle is injection-molded into a mold hollow part, that is, a space in which the boss 230 is formed.

Unlike the cold runner injection-molding, the hot runner maintains the resin in a molten state from a high temperature state and the hot runner manifold, the sprue 311, the hot runner part 313, and the like are mounted to an electric heater (not illustrated).

As illustrated in a lower picture of FIG. 6, the formed resin substance 245a and the gate residual substance 245b are left in the formed resin finished in the mold through the hot runner injection-molding.

Thus, a step of demolding the formed resin formed in the forming of the boss 230 from the mold, removing the formed resin covering an upper side of the hub 210, and exposing an inner peripheral surface of the hub 210 to perform a turning operation on the boss is performed.

If the boss turning step is performed, as illustrated in FIG. 2, the worm wheel including the inner tube 231, the outer tube 233, the separation plate 237, the rib 235, and the reinforcing part 239 is finished.

According to the present invention, a worm wheel of a reducer of an electric power steering apparatus can be manufactured by integrally injection-molding a hub, a boss, and a gear forming part, thereby making it possible to increase a forming performance of the worm wheel and reduce an amount of material, and increasing a mechanical durability and frictional characteristics of the worm wheel to allow the reducer to to be stably used for a long time.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A worm wheel of an electric power steering apparatus which has a central portion coupled to a steering shaft and an outer periphery coupled to a worm shaft to provide an assistant steering force, the worm wheel comprising:
a hollow hub into which the steering shaft is inserted;
a gear forming part having a worm wheel gear engaged with a worm gear of the worm shaft at an outer periphery thereof; and
a boss integrally formed between an outer periphery of the hub and an inner periphery of the gear forming part.

2. The worm wheel as claimed in claim 1, wherein an uneven part is formed on an outer peripheral surface of the hub.

3. The worm wheel as claimed in claim 2, wherein the gear forming part has a small diameter portion protruding inward and formed circumferentially on an inner peripheral surface, and a plurality of bosses protruding axially are formed on upper and lower surfaces of the small diameter portion, respectively.

4. The worm wheel as claimed in claim 1, wherein the boss includes an inner tube surrounding an outer peripheral surface of the hub, an outer tube surrounding an inner peripheral surface of the gear forming part, and a separation plate separating opposite circumferential surfaces of the inner tube and the outer tube such that the opposite circumferential surfaces of the inner tube and the outer tube are symmetrical upward and downward and radially connecting the opposite circumferential surfaces of the inner tube and the outer tube.

5. The worm wheel as claimed in claim 4, wherein the boss has a plurality of ribs radially extending from an outer peripheral surface of the inner tube to be circumferentially spaced apart from each other by a distance, the ribs being integrally connected to an inner peripheral surface of the outer tube and the separation plate.

6. A method for manufacturing a worm wheel of an electric power steering apparatus, the method comprising:
injection-molding a molten resin in a mold to form a gear forming part having a worm wheel gear at an outer periphery thereof and having a small diameter portion circumferentially formed at an inner periphery thereof and protruding inward and a plurality of bosses protruding axially from an upper surface and a lower surface of the small diameter portion, respectively; and
inserting a hub into a center of the gear forming part to fix the hub to the mold and injection-molding a molten resin between an outer periphery of the hub and an inner periphery of the gear forming part to form a boss.

7. The method as claimed in claim 6, further comprising:
demolding the formed resin formed in the forming of the gear forming part from the mold, removing the formed resin covering an inner side of the small diameter portion, and exposing an inner peripheral surface of the small diameter portion to perform a turning operation on the gear forming part.

8. The method as claimed in claim 7, further comprising:
demolding the formed resin formed in the forming of the boss from the mold, removing the formed resin covering an upper side of the hub, and exposing an inner peripheral surface of the hub to perform a turning operation on the boss.
